(19) United States
(12) Patent Application Publication
(10) Pub. No.: US 2016/0181027 A1
(43) Pub. Date: Jun. 23, 2016

(54) METHOD FOR PRODUCING CIRCUIT-BREAKER POLE PARTS

(71) Applicant: DOW GLOBAL TECHNOLOGIES LLC, Midland, MI (US)

(72) Inventors: Yewen Cao, Shanghai (CN); Huan Chen, Beijing (CN); Kwanho Chang, Lake Jackson, TX (US)

(21) Appl. No.: 14/907,319

(22) PCT Filed: Aug. 22, 2013
(86) PCT No.: PCT/CN2013/082057

§ 371 Date: Jan. 25, 2016

(51) Int. Cl. H01H 11/00; H01H 33/662

(52) U.S. Cl. CPC H01H 11/00; H01H 33/66207

(57) ABSTRACT

A process for producing a circuit-breaker pole part for use in a medium-voltage or high-voltage circuit-breaker comprising adjoining (a) an inner vacuum interrupter layer, (b) an intermediate compensation layer, and (c) an outer insulating sleeve layer, wherein the intermediate compensation layer is disposed between the inner vacuum interrupter layer and the outer insulating sleeve layer; wherein said layers are integrated with each other to form a circuit-breaker pole part; and wherein the intermediate compensation layer comprises the reaction product of (I) an epoxy-terminated prepolymer and (II) a curing agent; and a circuit-breaker pole part produced by the above process.

### FIELD

The present invention is related to a method for producing circuit breaker pole parts.

### BACKGROUND

The construction of a circuit breaker pole part may include various designs and heretofore, circuit breaker pole parts have been made from various materials. For example, DE102004060274A1 discloses a circuit breaker pole part which includes an inner vacuum interrupter, an intermediate compensating or compensation layer, and an outer insulating or insulation sleeve for example as shown in FIG. 1. FIG. 2, which is a magnified portion, partly in cross-section view of FIG. 1, shows a circuit breaker pole part, generally indicated by numeral 10, including an inner vacuum interrupter 11, an intermediate compensation layer 12, an outer insulating sleeve 13, and an adhesive coupling agent 14 disposed in-between the inner vacuum interrupter 11 and the intermediate compensation layer 12; and an adhesive coupling agent 14 disposed in-between the intermediate compensation layer 12 and the outer insulating sleeve 13.

A circuit breaker pole part is usually integrated in a medium-voltage or high-voltage circuit breaker, especially a medium-voltage circuit breaker. The medium-voltage circuit breaker typically is rated at between 1 kV and 72 kV of a high current level. It is critical that the materials of construction of the circuit breaker pole part including the circuit breaker pole part's inner vacuum interrupter 11, intermediate compensation layer 12, and outer insulating sleeve 13 be able to operate under these medium-voltage or high-voltage conditions.

The main purpose of an intermediate compensation layer in a circuit breaker pole part is to compensate the different coefficients of thermal expansion between the material in the inner vacuum interrupter layer and the insulation material in the outer sleeve layer of the pole part, thereby avoiding possible crack initiation. The most commonly used material for a compensation layer is silicone rubber. However, silicone rubber tends to impair dielectric properties and durability of the circuit breaker due to the silicone rubber exhibiting poor adhesion to the inner and outer layers of the circuit breaker. For example, DE102004060274A1 discloses a circuit breaker pole part which includes an intermediate compensation layer made of silicone material which is deleterious to the properties of the circuit breaker pole part. A material for the compensation layer is needed that will tightly adhere to inner and outer layers and that has a shear strength of more than 2 MPa, as measured by ASTM D3528 (1996).

U.S. Patent Application Publication No. 2008/0142485A1 discloses a method for producing a circuit breaker pole part wherein the outer insulating sleeve of the circuit breaker pole part is produced in a plastic injection-molding process and wherein the inner vacuum chamber is encapsulated by an injection molding step. The insulating sleeve is preferably produced from a plastic or a rubber-elastic material. Prior to the plastic embedding, the vacuum chamber can be encased by an intermediate compensation layer. To achieve satisfactory compatibility among different boundary layers of the circuit breaker pole part of the above Application, an additional bonding agent is required for use in the method described in the above Application. In addition, the doping procedure described in the above Application for the bonding-agent is time-consuming. Furthermore, the method described in the Application requires several individuals to perform the doping process, which takes about 20 minutes for each product (doping process is carried out 2 times for each product), and thus, the disclosed procedure in the above Application for producing a circuit breaker pole part is inefficient.

EP2407990A1 provides another approach for producing a circuit breaker pole part. In the method described in EP2407990A1, the intermediate compensating layer is composed of an adhesive material which combines a mechanical compensation function with a adhesive function in the one adhesive intermediate compensating layer. The adhesive material layer typically has a thickness of 0.5 millimeters to 5 millimeters and is applied on the surface of the inner vacuum chamber by taping or bonding the adhesive material in a solid form; or by spraying, coating or dipping of the adhesive material in a liquid form. The outer insulating sleeve is selected from an epoxy material, a thermal plastic material, a silicone rubber material or a silicone gel material. In the method of EP2407990A1, the adhesive material is selected from an acrylate double side adhesive film, a hot melt film, an acryl adhesive, a co-polyamide hot melt, a polyamide, a polyolefin, or a polyester. All the above adhesive materials disclosed in EP2407990A1 have poor mechanical properties. For example, the adhesive materials have a compression strength of less than 1 MPa as measure by ASTM D 575 (1991) when used at 150° C., which is the curing temperature of the outer epoxy sleeve.

### SUMMARY

Some of the disadvantageous of the structures for circuit breaker pole parts of the prior art have been overcome by the circuit-breaker pole part of the present invention. For example, the circuit-breaker pole part of the present invention advantageously incorporates a compensating layer with a compression strength of more than 1 MPa at 150° C.; and an inner and an outer layer with a shear strength of more than 2 MPa.

One embodiment of the present invention is directed a process for producing a circuit-breaker pole part including adjoining together: (a) an inner vacuum interrupter layer, (b) an intermediate compensation layer, and (c) an outer insulating sleeve layer, wherein the intermediate compensation layer is disposed between the inner vacuum interrupter layer and the outer insulating sleeve layer; wherein said layers are integrated with each other to form a circuit-breaker pole part; and wherein the intermediate compensation layer comprises the reaction product of an epoxy-terminated prepolymer and a curing agent.

Another aspect of the present invention relates to a circuit breaker pole part for use in a medium-voltage or high-voltage circuit breaker including (a) an inner vacuum interrupter layer, (b) an intermediate compensation layer, and (c) an outer insulating sleeve layer; wherein the intermediate compensation layer is disposed between the inner vacuum interrupter layer and the outer insulating sleeve layer; wherein said layers are integrated with each other to form a circuit-breaker pole part; and wherein the intermediate compensation layer comprises the reaction product of an epoxy-terminated prepolymer and a curing agent.

The epoxy-terminated prepolymer is formed for example by reacting an amine with an excess of an epoxide, wherein the amine such as a polyoxyalkyleneamine has at least 3 active hydrogen atoms.

In one embodiment, the intermediate compensation layer may be formed by reacting the above epoxy-terminated prepolymer with a curing agent. For example, the curing agent can be at least one amine or at least one polyamide having 2 to 5 active hydrogen atoms. The amine-cured epoxy elastomeric material combines the mechanical compensation function of silicone rubber with excellent adhesive performance. For example, one property of the amine-cured epoxy elastomeric material can include a shear strength of more than 2 MPa when using ceramic material and epoxy resin material. As a result, introducing the amine-cured epoxy elastomeric material into a circuit breaker pole part can reduce the partial discharge of the circuit breaker pole part to less than about 0.1 pico-coulomb under rated voltage, even after 6 cycles of −20° C. to 100° C.

One objective of the present invention is directed to increasing the bonding strength of the compensation layer used in a circuit breaker pole part by using an amine-cured epoxy elastomeric material for the compensation layer of a circuit breaker pole part.

Some of the advantages of the present invention include: (1) increasing the shear strength of a buffer layer with the inner and outer layers of the circuit-breaker pole part to more than about 2 MPa such that the production procedure is simplified and the durability of the final product is enhanced; and (2) keeping the buffer layer compression strength to more than about 1 MPa at 150° C. and keeping the weight loss, at 150° C. for 8 hours, of the buffer layer to a minimum or zero such that the integrity of the final product is maintained.

### BRIEF DESCRIPTION OF THE DRAWINGS

For the purpose of illustrating the present invention, the drawings show a form of the present invention which is presently preferred. However, it should be understood that the present invention is not limited to the embodiments shown in the drawings.

FIG. 1 is a schematic diagram showing a circuit breaker pole part of the prior art with the various layers that make up the structure of the circuit breaker pole part.

FIG. 2 is a cross-sectional view, enlarged portion of the various layers of the prior art circuit-breaker pole part shown in FIG. 1.

FIG. 3 is a cross-sectional view, enlarged portion of the various layers, including a compensation layer, that make up the structure of a circuit breaker pole part of the present invention.

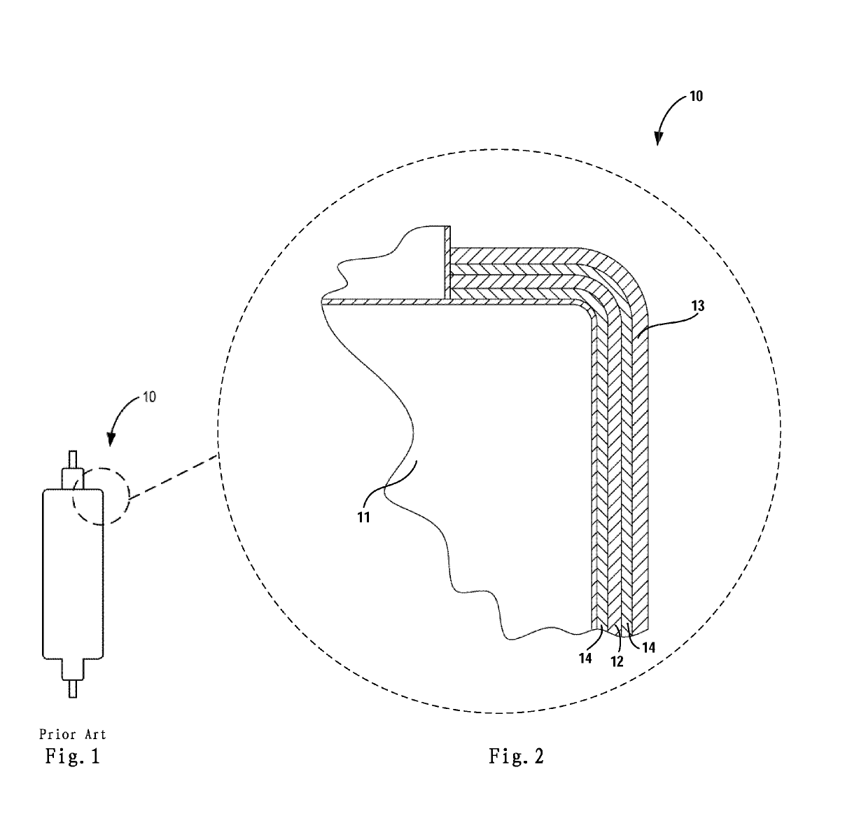

### DETAILED DESCRIPTION

In one broad scope, the present invention includes a process for producing a circuit-breaker pole part including adjoining together: (a) an inner vacuum interrupter layer, (b) an intermediate compensation layer, and (c) an outer insulating sleeve layer. The circuit breaker pole part; advantageously includes a compensation layer in which the compensation layer is derived from a curable elastomeric epoxy resin composition or formulation. For example, the intermediate compensation layer can comprise the reaction product of an epoxy-terminated prepolymer and a curing agent. In addition, the intermediate compensation layer is disposed between the inner vacuum interrupter layer and the outer insulating sleeve layer.

The curable elastomeric epoxy composition used to form the compensation layer includes for example (a) an epoxy resin; and (b) a hardener. The epoxy resin broadly includes an epoxy-terminated prepolymer formed by reacting a polyoxyalkyleneamine with an excess of epoxide. And, the hardener broadly includes a curing agent such as for example at least one amine or polyamide.

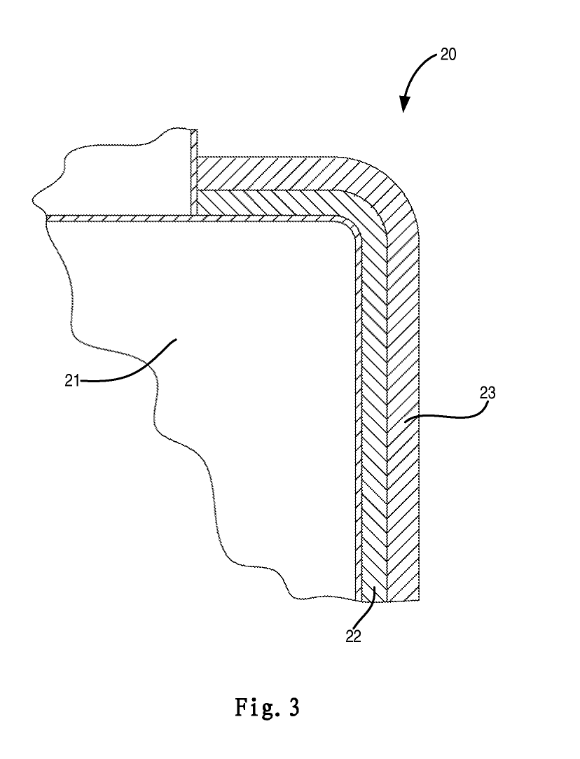

With reference to FIG. 3, there is shown one embodiment of a circuit-breaker pole part, generally indicated by numeral 20, including an inner vacuum interrupter layer 21, an intermediate compensation layer 22, and an outer insulating sleeve layer 23 adjoined together. In one embodiment, the circuit-breaker pole part 20 shown in FIG. 3 can be produced for example by adjoining, bonding and integrating the (a) the inner vacuum interrupter layer 21, (b) the intermediate compensation layer 22, and (c) the outer insulating sleeve layer 23 together. The layers integrated with each other form a circuit-breaker pole part structure. The intermediate compensation layer 22 can be a reaction product prepared for example by reacting (I) epoxy-terminated prepolymer and (II) a curing agent. The circuit-breaker pole part is advantageously used in medium-voltage or high-voltage circuit-breakers.

The materials useful forming the inner vacuum interrupter layer 21 can include conventional materials such as for example ceramic. Although not limited to any one particular shape, generally the vacuum interrupter layer 21 is cylindrical and is closed at both ends of the cylinder with, for example, metallic covers.

The materials useful forming the outer insulating sleeve layer 23 can include conventional materials such as for example thermosetting-plastic epoxy resin mixtures, or thermoplastics. The materials used for the insulating sleeve layer 23 contributes to the increase of the external dielectric strength and the mechanical rigidity of the outer insulating sleeve layer 23 and the circuit-breaker pole part overall.

One preferred embodiment of the present invention is directed to the intermediate compensation layer 22 used to manufacture the circuit-breaker pole part. For example, the intermediate compensation layer 22 can be prepared by reacting: (I) an epoxy-terminated prepolymer, and (II) a curing agent to form an elastomeric resin-cured material. Any well known method for carrying out the reaction of the epoxy-terminated prepolymer and the curing agent to form the intermediate compensation layer reaction product can be used in the present invention.

In one embodiment, for example, a process useful for preparing the epoxy-terminated prepolymer elastomeric resin (I) is described in WO2012/030338A1, incorporated herein by reference. Also, described in WO2012/030338A1 is a process for preparing an amine-cured epoxy elastomeric material useful as the intermediate compensation layer in the present invention which includes curing the epoxy-terminated prepolymer with a curing agent, for example, an amine curing agent.

Generally, in one embodiment, the epoxy-terminated prepolymer may be formed by reacting (i) a polyoxyalkyleneamine with (ii) an excess of an epoxide compound. The polyoxyalkyleneamine used to form the epoxy-terminated prepolymer can be selected from commercially available polyoxyalkyleneamines such as for example Jeffamine™ D-4000 or Jeffamine™ T-5000 from Huntsman Corporation. The epoxide compound used to react with the polyoxyalkyleneamine described above to form the epoxy-terminated prepolymer can be for example any conventional epoxide (or epoxy) compound such as any of the epoxy compounds described in Lee, H. and Neville, K., Handbook of Epoxy Resins, McGraw-Hill Book Company, New York, 1967, Chapter 2, pages 2-1 to 2-27, incorporated herein by reference.

The polyoxyalkyleneamine useful in the present invention generally has a molecular weight of from about 3,000 to about 20,000 in one embodiment, from about 4000 to about 10,000 in another embodiment, and from about 5000 to about 8,000 in still another embodiment. The active hydrogen atom in the polyoxyalkyleneamine is generally in an amount of from about 3 to about 12 in one embodiment, and from 4 to about 6 in another embodiment.

Generally, the amount of polyoxyalkyleneamine compound used to form the elastomeric resin composition of the present invention, may be for example, from 20 weight percent (wt %) to about 70 wt % in one embodiment, from about 30 wt % to about 65 wt % in another embodiment; and from about 40 wt % to about 60 wt % in still another embodiment, based on the total weight of the elastomeric resin composition.

In a preferred embodiment, the epoxy compound may include for example epoxy resins based on reaction products of polyfunctional alcohols, phenols, cycloaliphatic carboxylic acids, aromatic amines, or aminophenols with epichlorohydrin. A few non-limiting embodiments include, for example, bisphenol A diglycidyl ether, bisphenol F diglycidyl ether, resorcinol diglycidyl ether, and triglycidyl ethers of para-aminophenols. Other suitable epoxy resins known in the art include for example reaction products of epichlorohydrin with o-cresol novolacs, hydrocarbon novolacs, and, phenol novolacs. The epoxy compound may also be selected from commercially available epoxy resin products such as for example, D.E.R. 383, D.E.R. 331®, D.E.R.332, D.E.R. 354, D.E.R. 580, D.E.N. 425, D.E.N. 431, D.E.N. 438, D.E.R. 736, or D.E.R. 732 epoxy resins available from The Dow Chemical Company.

Generally, the amount of the epoxide used to produce the epoxy-terminated prepolymer is used in an excess amount; and can be from about 20 wt % to about 80 wt % in one embodiment, from about 30 wt % to about 70 wt % in another embodiment; and from about 40 wt % to about 60 wt % in still another embodiment; based on the weight of the components to make the epoxy-terminated prepolymer composition.

In general, the curing agent (also referred to as a hardener or crosslinking agent), component (II), is blended with the epoxy resin compound, component (I), to prepare the elastomeric resin composition as described above.

Examples of the curing agent compound useful in the present invention to form the elastomeric resin composition of the present invention may include for example at least one of any of the following curing agents: an amine, a polymer amine, a polyamide, an anhydride, a dicyandiamide, or mixtures thereof.

In general, the equivalent weight of the curing agent can be from about 10 to about 200 in one embodiment and from about 35 to about 100 in another embodiment. In general, the active hydrogen atom amount of the curing agent can be from about 2 to about 5 in one embodiment.

Generally, the epoxy:amine group molar ratio used in the present invention can be from about 0.5 to about 1.5 in one embodiment and from about 0.8 to about 1.2 in another embodiment.

In the present invention, the amine cured epoxy elastomeric material, forming the intermediate compensation layer, exhibits several beneficial properties; and therefore the elastomeric material is leveraged into circuit breaker pole parts as the compensating layer, remarkably improving the circuit breaker pole part's dielectric properties and durability. Conventional epoxy-based elastomeric materials are traditionally viewed as being brittle. However, the present invention epoxy elastomeric material, which forms the intermediate compensation layer, has greater flexibility than the conventional epoxy-based elatormeric materials. For example, the elongation of the amine-cured epoxy elastomeric material is at least 50% as measured by ASTM D1708 (2010).

In addition, the epoxy elastomers have favorable properties such as for example high strength with a tensile strength of more than about 6 MPa, high thermal stability with no weight loss at 150° C. for 8 hours, softness with a hardness of less than about 95 A, a favorable bonding ability, and excellent insulation properties among other beneficial properties.

The resultant compensation layer formed from the elastomeric resin composition has several beneficial properties. For example, the compression strength of the compensation layer made from the amine-cured epoxy elastomeric material at 150° C. is increased sufficient to be used as the compensation layer of a circuit breaker pole part. Generally, the compression strength at 150° C. can be from about 1 to about 10 MPa in one embodiment, from about 1.5 to about 5 MPa in another embodiment, and from about 2 to about 3 MPa in still another embodiment, as measured by ASTM D 575 (1991).

The resultant compensation layer also exhibits excellent insulation properties. For example, the dielectric strength of the compensation layer made from the amine-cured epoxy elastomeric material is high enough to be used as the insulation layer. Generally, the dielectric strength can be from about 10 kV/mm to about 50 kV/mm in one embodiment, from about 15 kV/mm to about 35 kV/mm in another embodiment, and from about 20 kV/mm to about 30 kV/mm in still another embodiment, as measured by ASTM D149-95a.

In addition, the compensation layer cured product (i.e. the cross-linked product made from the curable elastomeric material composition) of the present invention shows several improved properties over conventional silicon resins or other conventional epoxy cured resins. For example, the cured product of the present invention may advantageously have a high shear strength with cured epoxy. For example, with cured epoxy, generally the cured product of the present invention exhibits a shear strength of between 2 and 100 MPa in one embodiment, between about 5 and 50 MPa in another embodiment, and between about 10 and 20 MPa in still another embodiment. The shear strength of the cured product with cured epoxy can be measured by the method described in ASTM D3528 (1996).

The compensation layer cured product (i.e. the cross-linked product made from the curable elastomeric material composition) of the present invention also can have excellent thermal stability against high temperature. For example, the weight loss of the compensation layer can be below about 0.2 wt % at 120° C. for 2 hours in one embodiment, below about 0.1 wt % at 140° C. for 4 hours in another embodiment, and below about 0.05 wt % at 150° C. for 8 hours in still another embodiment, as measured using Thermo Gravimetric Analyzer (TGA) in nitrogen.

The elastomeric resin composition of the present invention is used to produce the compensation layer for a circuit breaker pole part which includes adjoining (a) the inner vacuum interrupter layer 21, (b) the intermediate compensation layer 22, and (c) the outer insulating sleeve layer 23 such that the layers are integrated with each other to form a circuit-breaker pole part.

The process used for manufacturing a circuit breaker pole part can be any conventional method known in the art. For example, U.S. Patent Application Publication No. 2008/0142485 and EP 2 407 990 A1, each incorporated herein by reference describe methods for producing a circuit breaker pole part and integrating the layers with each other to form the circuit-breaker pole part.

In a broad scope, the process for producing a circuit-breaker pole part with the layered structure in accordance with the present invention for use in a medium-voltage or high-voltage circuit-breaker includes adjoining (a) an inner vacuum interrupter layer, (b) an intermediate compensation layer, and (c) an outer insulating sleeve layer; wherein the intermediate compensation layer is disposed between the inner vacuum interrupter layer and the outer insulating sleeve layer; wherein said layers are integrated with each other to form a circuit-breaker pole part; and wherein the intermediate compensation layer (b) comprises the reaction product of (I) an epoxy-terminated prepolymer and (II) a curing agent.

In one embodiment, the method for producing a circuit breaker pole part can include the following steps:

(a) providing an inner vacuum interrupter layer and an outer insulating sleeve layer;

(b) forming a curable elastomeric resin composition including (I) at least one epoxy-terminated prepolymer, and (II) at least one amine curing agent compound blended together to form the curable elastomeric resin composition;

(c) disposing the curable elastomeric resin composition between the inner vacuum interrupter layer and the outer insulating sleeve layer in a mold; and

(d) curing the curable elastomeric resin composition in the mold to form a compensation layer between the inner vacuum interrupter layer and the outer insulating sleeve layer; wherein the resultant cured compensation layer adjoined between the inner vacuum interrupter layer and the outer insulating sleeve layer is adapted for use as a circuit breaker pole part.

In still another embodiment, the method for producing a circuit breaker pole part can include the following steps:

(a) providing a first mold;

(b) inserting an inner vacuum interrupter layer into the first mold;

(c) preheating the first mold with the inner vacuum interrupter layer in the mold;

(d) providing a curable elastomeric resin formulation comprising (I) at least one epoxy-terminated prepolymer, and (II) at least one amine curing agent compound blended together to form a curable elastomeric resin formulation;

(e) injecting the curable elastomeric resin formulation into the preheated first mold to dispose the curable elastomeric resin formulation on at least a portion of the inner vacuum interrupter layer;

(f) curing the curable elastomeric resin formulation in the first mold to form a first composite member comprising a cured compensation layer bonded to an inner vacuum interrupter layer;

(g) removing (i.e., de-molding) the first composite member from the first mold;

(h) placing the first composite member formed in the first mold into a second preheated mold;

(i) injecting a curable epoxy resin into the second preheated mold to dispose the curable epoxy resin on at least a portion of the cured compensation layer;

(j) curing the curable epoxy resin in the second mold to form a second composite member comprising a cured outer insulating sleeve layer bonded to the compensation layer of the first composite member; and

(k) removing (i.e., de-molding) the second composite member from the second mold; wherein the second composite member comprising a cured outer insulating sleeve layer, the compensation layer and the inner vacuum interrupter layer is adapted for use as a circuit-breaker pole part.

### EXAMPLES

The following examples and comparative examples further illustrate the present invention in detail but are not to be construed to limit the scope thereof.

Various terms and designations used in the following examples are explained herein below:

Jeffamine T5K is polyoxyalkyleneamine with a molecular weight of 5000 and an active hydrogen atom amount of 5; and is commercially available from Huntsman Corporation.

D.E.R.™ 383 is an epoxide compound with an equivalent weight of 180 g/mol; and is commercially available from The Dow Chemical Company.

Isopropanolamine (MPA) is a curing agent and is commercially available from The Dow Chemical Company.

### Example 1

### Part A: Preparation of Coated Vacuum Interrupter

In this Example, an epoxy-terminated prepolymer (ETP), was prepared by reacting Jeffamine T5K with an equal weight of D.E.R. 383 in the presence of a curing agent isopropanolamine (MPA). 2000 g of ETP was mixed with 164 g of MPA using a FlackTek speedmixer at 2500 revolutions per minute (rpm) for 2 minutes (min), and then the resulting mixture was immediately stored in a freezer at −10° C. for 20 hours (hr).

After 20 hr the ETP/MPA mixture was removed from the freezer and then manually transferred into a 40° C. cup. After 20 min in the 40° C. cup, the mixture was subsequently transferred to an 80° C. mold with a vacuum interrupter using an air compressor. After the 80° C. mold was filled with the mixture, the mold was heated to 100° C., and held at this temperature for 25 min.

After 25 min, the ETP/MPA-coated vacuum interrupter was de-molded.

### Part B: Preparation of Embedded Pole with Compensation Layer

The ETP/MPA-coated vacuum interrupter prepared above was fixed onto a 140° C. mold. Then, epoxy resin was injected into the 140° C. mold and cured for 30 min. The mold was opened and the resulting embedded pole part was taken out of the mold. The resulting embedded pole part had ETP/MPA as the compensation layer.

The ETP/MPA-containing embedded pole part was post-cured at 140° C. for another 10 hr before undergoing testing procedures.

### Part C: Test Methods

The ETP/MPA-containing embedded pole part prepared as described above was tested to determine partial discharge, a localized dielectric breakdown of a small portion under high voltage, in accordance with the test method procedure described in GB/T 7354-2003 (2004). The appearance of the embedded pole part was determined by visually observing the resultant embedded pole part with the naked eye.

The following Table I shows the performance of the ETP/MPA-containing embedded pole part prepared as described above.

TABLE I
Results

| Property | ETP/MPA-Containing Embedded Pole Part | |
|---|---|---|
| Partial discharge | 0 (40 kV) | 30 pico-coulomb |
| under different voltages | | (48 kV) |
| Appearance | No cracks | |
| after 6 cycles of heat- | | |
| frozen | | |
| Partial discharge | 0 (40 kV) | 30 pico-coulomb |
| under different voltages | | (48 kV) |
| after 6 cycles of heat- | | |
| frozen | | |

Note:
During one heat-frozen cycle, the sample was frozen to −20° C. and held at −20° C. for 5 hr. Then, the sample was heated to 100° C. and held at 100° C. for 5 hr.

In the circuit breaker pole part industry, the partial discharge requirement for embedded poles is <0.5 pico-coulomb under 14.4 kV. The present invention embedded pole part using ETP/MPA as the compensating material has no partial discharge even less than 40 kV. Therefore, the embedded pole part of the present invention clearly meets the industrial requirement on partial discharge.

1. A process for producing a circuit-breaker pole part for use in a medium-voltage or high-voltage circuit-breaker comprising adjoining (a) an inner vacuum interrupter layer, (b) an intermediate compensation layer, and (c) an outer insulating sleeve layer, wherein the intermediate compensation layer is disposed between the inner vacuum interrupter layer and the outer insulating sleeve layer; wherein said layers are integrated with each other to form a circuit-breaker pole part; and wherein the intermediate compensation layer comprises the reaction product of (I) an epoxy-terminated prepolymer and (II) a curing agent.

2. The process of claim 1, wherein the curing agent (II) is at least one amine curing agent compound.

3. The process of claim 1, wherein the epoxy-terminated prepolymer compound (I) comprises the reaction product of (i) a polyoxyalkyleneamine compound and (ii) an epoxide compound.

4. The process of claim 3, wherein the polyoxyalkyleneamine compound (i) has from 3 to about 12 active hydrogen atoms.

5. The process of claim 3, wherein the concentration of the polyoxyalkyleneamine compound (i) comprises from about 20 weight percent to about 80 weight percent.

6. The process of claim 3, wherein the epoxide compound (ii) has from 2 to about 5 epoxy groups.

7. The process of claim 3, wherein the concentration of the epoxide compound (ii) comprises from about 20 weight percent to about 80 weight percent.

8. The process of claim 1, wherein the curing agent (II) has from 2 to about 5 active hydrogen atoms.

9. The process of claim 1, wherein the epoxy amine group molar ratio is from about 0.5 to about 1.5.

10. A circuit-breaker pole part prepared by the process of claim 1.

11. A circuit breaker pole part for use in a medium-voltage or high-voltage circuit breaker comprising (a) an inner vacuum interrupter, (b) an intermediate compensation layer, and (c) an outer insulating sleeve; wherein the intermediate compensation layer is disposed between the inner vacuum interrupter layer and the outer insulating sleeve layer; wherein said layers are integrated with each other to form a circuit-breaker pole part; and wherein the intermediate compensation layer comprises the reaction product of (I) an epoxy-terminated prepolymer and (II) a curing agent.

12. (canceled)

13. (canceled)

14. A method for producing a circuit breaker pole part comprising the steps of:
(a) providing a first mold;
(b) inserting an inner vacuum interrupter layer into the first mold;
(c) preheating the first mold with the inner vacuum interrupter layer in the mold;
(d) providing a curable elastomeric resin formulation comprising (I) at least one epoxy-terminated prepolymer, and (II) at least one amine curing agent compound blended together to form a curable elastomeric resin formulation;
(e) injecting the curable elastomeric resin formulation into the preheated first mold to dispose the curable elastomeric resin formulation on at least a portion of the inner vacuum interrupter layer;
(f) curing the curable elastomeric resin formulation in the first mold to form a first composite member comprising a cured compensation layer bonded to an inner vacuum interrupter layer;
(g) removing the first composite member from the first mold;
(h) placing the first composite member formed in the first mold into a second preheated mold;
(i) injecting a curable epoxy resin into the second preheated mold to dispose the curable epoxy resin on at least a portion of the cured compensation layer;
(j) curing the curable epoxy resin in the second mold to form a second composite member comprising a cured outer insulating sleeve layer bonded to the compensation layer of the first composite member; and
(k) removing the second composite member from the second mold; wherein the second composite member comprising a cured outer insulating sleeve layer, the compensation layer and the inner vacuum interrupter layer is adapted for use as a circuit-breaker pole part.

15. The method of claim 14, wherein the inner vacuum interrupter layer is ceramic.
